(19) United States
(12) Patent Application Publication
(10) Pub. No.: US 2026/0025233 A1
(43) Pub. Date: Jan. 22, 2026

(54) RELIABLE DATA DIODE TRANSMISSION USING ERASURE CODING

(71) Applicant: Oracle International Corporation, Redwood Shores, CA (US)

(72) Inventors: Eden Grail Adogla, Seattle, WA (US); Thomas Werner Kuehnel, Seattle, WA (US)

(73) Assignee: Oracle International Corporation, Redwood Shores, CA (US)

(21) Appl. No.: 18/776,084

(22) Filed: Jul. 17, 2024

(51) Int. Cl. H04L 1/00

(52) U.S. Cl. CPC H04L 1/0067; H04L 1/0042

(57) ABSTRACT

Techniques are disclosed for transmitting data across data diode of a cross domain system using an encoding algorithm. A sender node of the cross domain system can receive data for transmission across the cross domain system. The data can include a first number of data segments. The sender node can generate a datagram using the data and according to the encoding algorithm. The datagram can include a second number of data segments greater than the first number of data segments. The sender node can transmit the datagram to a receiver node of the cross domain system using a data diode. The receiver node can recover the data using at least a portion of the second number of data segments of the datagram.

### BACKGROUND

Cloud service providers can offer computing infrastructure for customers across several data centers. Some customers of the cloud service providers may demand heightened network security for their infrastructure, including “air-gapped” data centers that have highly restricted connectivity to external public networks. Transmitting data across the air gaps is possible but can lead to difficulties with limited or nonexistent two-way communication in the channel, including identifying dropped or lost data and other errors in the transmitted data. There is a need therefore for improved mechanisms for data transfer across data center air gaps.

### BRIEF SUMMARY

Embodiments of the present disclosure relate to transmitting data across an “air gap” present at a networking boundary of a data center. The data center can include a number of computing and networking resources (e.g., server devices, racks of server devices, network switches, etc.) for implementing cloud computing infrastructure (e.g., compute, storage, virtual networking, etc.). The data center can interface with external networks (e.g., public network like the Internet, etc.) using a cross domain system. The cross-domain system (CDS) can be any suitable number of computing devices and/or networking devices (e.g., switches, routers, etc.) to manage networking traffic into and out of the data center. The CDS may be the only networking interface of the data center that is accessible from an external data source for transmitting data into the data center. By using a CDS, the computing resources of the data center, as well as any other computing resources connected to the data center via a private network connection, can be protected from networking threats (e.g., malicious software, attacks, etc.). However, many networking protocols function with two-way communication between nodes. For example, a TCP connection includes acknowledgments transmitted from both endpoints when establishing the channel. A CDS is typically implemented using one or more data diodes that may only permit one-way communication and preventing implementation of two-way communication channels. Because retry requests and other feedback information is used to ensure correct transmission of a full data packet from a sender to a receiver, typical error checking in communication protocols over a CDS may be inoperable. To remedy this, a CDS of the present disclosure can implement an erasure coding algorithm to ensure complete delivery of data across a data diode.

One embodiment is directed to a method that can be performed by computer system implementing a CDS. The method can include receiving, by a sender node of the CDS, data for transmission across the CDS. The data can include a first number of data segments. The method can also include the sender node generating a datagram using the data and according to an encoding algorithm. The datagram can include a second number of data segments. The second number of data segments can be greater than the first number of data segments. The method can also include the sender node transmitting the datagram to a receiver node of the CDS using a data diode and recovering, by the receiver node, the data using at least a portion of the second number of data segments of the datagram.

Another embodiment is directed to a CDS comprising one or more processors and one or more memories storing instructions that, when executed by the one or more processors, cause the CDS to perform the method(s) disclosed herein.

Still another embodiment is directed to a computer-readable medium storing computer-executable instructions that, when executed by one or more processors of a CDS, cause the CDS to perform the method(s) disclosed herein.

### BRIEF DESCRIPTION OF DRAWINGS

FIG. 1 is a block diagram illustrating a cross domain system providing ingress into a secure network, according to some embodiments.

FIG. 2 is a simplified block diagram illustrating an erasure coding technique usable to transmit data across a data diode in a cross domain system, according to some embodiments.

FIG. 3 is a simplified block diagram illustrating a cross domain system including a plurality of data diodes usable for fully parallel transmission of data segments, according to some embodiments.

FIG. 4 is another simplified block diagram illustrating a cross domain system including a plurality of data diodes usable for partially parallel transmission of data segments, according to some embodiments.

FIG. 5 is a simplified block diagram illustrating a cross domain system with a limited egress channel for providing feedback information to a sender node, according to some embodiments.

FIG. 6 is a flow diagram of an example process for transmitting a datagram across a data diode using an encoding algorithm, according to some embodiments.

FIG. 7 is another flow diagram of an example process for updating a correction parameter for the encoding algorithm using an indication of a drop rate, according to some embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment.

### DETAILED DESCRIPTION

The adoption of cloud services has seen a rapid uptick in recent times. Various types of cloud services are now provided by various different cloud service providers (CSPs). The term cloud service is generally used to refer to a service or functionality that is made available by a CSP to users or customers on demand (e.g., via a subscription model) using systems and infrastructure (cloud infrastructure) provided by the CSP. Typically, the servers and systems that make up the CSP's infrastructure and which is used to provide a cloud service to a customer are separate from the customer's own on-premises servers and systems. Customers can thus avail themselves of cloud services provided by the CSP without having to purchase separate hardware and software resources for the services. Cloud services are designed to provide a subscribing customer easy, scalable, and on-demand access to applications and computing resources without the customer having to invest in procuring the infrastructure that is used for providing the services or functions. Various different types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

As indicated above, a CSP is responsible for providing the infrastructure and resources that are used for providing cloud services to subscribing customers. The resources provided by the CSP can include both hardware and software resources. These resources can include, for example, compute resources (e.g., virtual machines, containers, applications, processors), memory resources (e.g., databases, data stores), networking resources (e.g., routers, host machines, load balancers), identity, and other resources. In certain implementations, the resources provided by a CSP for providing a set of cloud services CSP are organized into data centers. A data center may be configured to provide a particular set of cloud services. The CSP is responsible for equipping the data center with infrastructure and resources that are used to provide that particular set of cloud services. A CSP may build one or more data centers.

For customers of the CSP who use secure, air-gapped data centers, the ability for the CSP to provide data and services from outside the data center can be limited by a cross domain system (also referred to as a cross domain solution). In some cases, the CSP may deploy software resources to the secure data centers to, for example, update deployed applications or provision an expansion of the data center. However, the air gap may be implemented with a cross domain system (CDS) that can include one or more data diodes. A CDS can refer to a combination of software and hardware configured to enforce restrictions on traffic between two security domains according to one or more security policies. The security domains may be generally referred to as a “high side,” the domain encompassing heightened security requirements on data due to confidentiality, classification, and the like, and the “low side,” the domain with lesser security restrictions. A data diode can be a unidirectional, protocol breaking electric, electronic, or electro-optical device for transmitting data between different data domains that need to not be connected directly to each other. Since data is only allowed to flow in one direction across the data diode, there it may be difficult to guarantee that any data payload (e.g., packet, datagram, data block, etc.) sent across the data diode arrives in full fidelity without performing additional operations like sending multiple duplicates of the data to ensure full fidelity in transmission. The difficulty is magnified when the payload is much larger than the largest datagram that can be sent across the data diode. Sending duplicates of the payload across redundant instances of cross-domain solutions can increase the likelihood that at least one copy of the data is successfully transmitted across the air gap. However, using multiple instances of a cross-domain solution to ensure reliable delivery of payloads can be wasteful.

The present disclosure is directed to a cross domain system (CDS) that is configured to support an encoding algorithm to reliable transmit a data payload across a data diode while minimizing the additional computational and infrastructure overhead needed to complete the transmission. The encoding algorithm may be an implementation of an erasure coding algorithm in which the data payload is broken into smaller segments and then appended with additional information that allows for the reconstruction of the data payload even if some number of segments are dropped or corrupted during the transmission. The CDS may be implemented at a secure data center and act as a networking interface for the data center while enforcing data security policies, data content filtering, content disarm and reconstruction, traffic control, and traffic filtering for the networking connection with the data center.

Erasure encoding allows for recovery of an original data payload while limiting the total amount of data transmitted to support the reconstruction. For example, the data to be transmitted across a data diode of a CDS can be broken into K segments. Rather than transmitting just the K segments of the payload, the erasure encoding algorithm can encode the data into N segments, with N greater than K, so that N-K additional segments of data are included for the transmission. For example, the erasure encoding algorithm can be a Reed-Solomon algorithm or similar algorithm. The number N-K of additional segments can be determined by a predicted drop rate for segments across the data diode of the CDS. For example, if the data diode drops (or corrupts) 40% of all segments transmitted, then N-K can be determined to be 40% of N.

The encoding can be done at the application layer of the external network (e.g., sending side or “low side”). For example, the CDS can include a device acting as a Smart Network Interface Card (“SmartNIC”) that can be configured as a sender node of the CDS. The SmartNIC can be attached to a computing device or network device of the secure data center and act as the (sole) external interface to the data center. Internal to the secure network, the CDS can include a receiver node that can recover the original data payload from any K number of transmitted segments. Once the data payload is recovered, the CDS components that filter data or enforce other data security policies can analyze the reconstructed data payload before passing it into the secure network.

In addition, the encoding algorithm can be updated based on feedback obtained from the secure network about the drop rate (e.g., the rate of lost, corrupted, or otherwise unusable data packets) of the data diode. Although the CDS limits two-way communication channels, a separate limited egress interface out from the secure network may allow for a low side receiver to particular types of data. For example, the particular data may be an indication of the data diode drop rate for a previous period of time. Using the actual drop rate can allow for the encoding algorithm to be updated to ensure that an optimal number of data segments is used for transmitting a data payload to ensure successful recovery without increasing the amount of data transmitted. In some instances, the limited egress can be a side channel from the secure network that automatically provides the particular data (e.g., drop rate information) at a particular interval (e.g., every five minutes, once per hour, once per day, etc.). In some other instances, the limited egress may provide the indications to external operations personnel (e.g., operations personnel of the CSP) that can then connect to the sender node of the CDS to provide the drop rate information.

Numerous advantages can be realized by the use of an erasure coding algorithm for transmitting across a data diode. As discussed briefly above, duplication of the data can improve the chances of a successful delivery, but can require marshalling significant additional computing resources to host the additional instances of the CDS to support the contemporaneous transmission of the duplicates. Moreover, the receiving computing device in the secure network must handle and maintain the duplicates until the complete data payload is verified, wasting storage and computational resources. By implementing an erasure coding algorithm, data payloads can be reliably transmitted across a single CDS without duplicating the payloads, thereby greatly reducing the amount of computing resources used to both implement additional CDS instances and to receive, store (if even temporarily), and verify duplicate payloads for each transmission. In addition, by adjusting the correction parameters based on drop rate information, the CDS can tune the encoding algorithm to best use the available bandwidth across the data diode by limiting the total number N of data segments for each payload that are needed to ensure successfully recovery at the receiver node in the secure network. These and other advantages will be made evident to one skilled in the art in the following discussion.

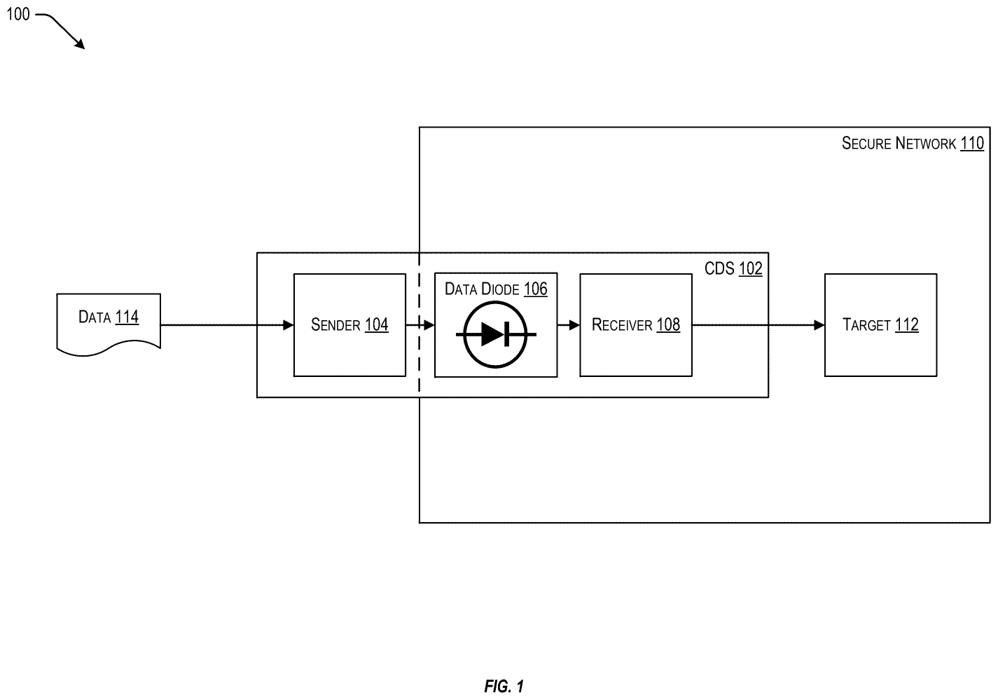

Turning now to the figures, FIG. 1 is a block diagram illustrating a cross domain system (CDS) 102 providing ingress into a secure network 110, according to some embodiments. The secure network 110 may be a part of a larger distributed computing system 100 that includes one or more data centers. For example, the secure network 110 may be a data center of a region and can include multiple pieces of physical infrastructure like server devices, racks of server devices, networking devices (e.g., switches, routers, gateways, etc.), and the like. The larger distributed computing system 100 can include external computing systems like the computing systems of a cloud service provider (CSP) that can communicate with the secure network 110 via the CDS 102. Infrastructure of the secure network (e.g., target 112) may connect to other parts of a customer's internal network, but only have a connection to an external public network (e.g., the Internet) via CDS 102.

The CDS 102 may be configured as a one-way-transfer device. The CDS 102 may act as a protocol breaker to prevent exploitation of potential vulnerabilities in complex communication protocols that rely on bidirectional data transfer on the same channel. The CDS 102 may include a data diode 106 to enforce one-way traffic on a single channel. In some examples, the CDS 102 may include one or more filters to filter traffic that is received through and/or sent out from the CDS 102. In some embodiments, the components of the CDS 102 may be implemented by any suitable combination of hardware and software to enforce one-way data transfer and traffic filtering. For example, data diode 106 may be implemented in hardware as an optical link that includes an optical transmitter (e.g., a laser, a light-emitting diode, etc.) and an optical receiver (e.g., a photosensitive transistor). Traffic (e.g., packets, frames, messages, datagrams, etc.) received at a first terminal (e.g., optical transmitter) of the data diode may be sent to the second terminal (e.g., optical receiver) of the data diode, but traffic received at the second terminal cannot be sent to the first terminal. In some embodiments, data diode 106 may be implemented with software (e.g., virtual data diodes) and may be provided as a service (e.g., a cloud-based service). In some embodiments, the CDS 102 can include both an ingress channel and an egress channel that represent one-way data pathways for traffic into and out from the secure network 110, respectively. The ingress channel may represent a low-to-high channel (that is to say, a channel from a lower security domain to a higher security domain), while the egress channel may represent a high-to-low channel (a channel from a higher security domain to a lower security domain).

The CDS 102 may be one or more computing devices and/or networking devices configured to perform the operations described herein with respect to enforcing one-way data transfer, filtering, traffic modulation, traffic blocking/control, and erasure encoding of data. In some embodiments, CDS 102 may be implemented as part of a smart network interface card (SmartNIC) or similar device (e.g., bump in the wire). In some other embodiments, the CDS 102 may be implemented within other computing infrastructure of the secure network 110 (e.g., as a service hosted on one or more computing devices of the secure network 110). In one example, a sender node 104 of the CDS 102 may be implemented on a SmartNIC connected to one computing device of the secure network 110 (e.g., one server device on a rack in a data center of secure network 110), while the data diode 106 and a receiver node 108 may be implemented on the computing device (e.g., a host environment, VM, or bare metal instance of the server device to which the SmartNIC is connected). The incoming network connection at the SmartNIC may then be the only physical networking interface to an external network.

The CDS 102 can include a sender node 104 and receiver node 108. Sender node 104 and receiver node 108 can be configured as the input and output terminals of the diode. For example, the sender node 104 can be a “pitcher” terminal and the receiver node 108 can be a “catcher” terminal. The pitcher terminal can be configured as the input terminal of the data diode, while the catcher terminal can be configured as the output terminal. Both pitcher and catcher terminals may be configured to apply content filtering to data payloads (e.g., packets, frames, messages, etc.) received/transmitted by the data diodes. In some embodiments, sender node 104 and receiver node 108 may also be configured to transform the data payloads into signals corresponding to the type of transfer mechanism enforced by the data diode (e.g., convert electrical signals to optical signals as described above for an optical diode). The receiver node 108 can also be configured to route data to targets in the secure network 110. For example, receiver node 108 can transmit data received through the CDS 102 to target 112 in the secure network 110. Target 112 may be a device (e.g., a VM) within the secure network 110.

The sender node 104 can be configured to receive data 114 over one or more networks, including an external public network. The sender node 104 can be configured to apply an encoding algorithm to generate a datagram for transmission across the data diode 106. For example, data 114 can be a message, file, or other data object (or portion thereof) to be sent to target 112. The data 114 can be partitioned into a plurality of data segments depending on the particular encoding algorithm used. For example, the encoding algorithm can be an erasure code algorithm characterized by a 4-2 scheme, in which the data is partitioned into four data segments and two parity segments. In this example, the data 114 may be a 512 KB file and can be segmented into six 128 KB segments. Each of the six segments may have a portion of the original data and a portion of the parity data, so that the original data can be reconstructed from any four of the six segments. In this example, the sender node 104 uses the original 512 kB data and generates a datagram having six, 128 KB segments for transmission across the CDS 102.

The sender node 104 can be configured to apply the encoding algorithm to generate the datagram based on a transmission protocol used for communication with the sender and/or with the data diode 106. For example, the sender node 104 can encode the data 114 so that the resulting segments of the datagram correspond to the segment size of a transport layer protocol like TCP or UDP, for instance 576 byte segments. In this way, the data 114 may be received at the sender node 104 in segments according to the transmission protocol, so that the data payload of each segment of the received data 114 can be the number of data segments of the data to be transmitted across the CDS 102. The sender node 104 can then generate the datagram for transmission by using the encoding algorithm to produce a second number of data segments. The datagram can be sent by the sender node 104 across the data diode 106 one segment at a time sequentially.

More generally, the sender node 104 can generate a datagram that has N segments from data 114 that has K segments of data, with N greater than K. The number N-K of additional data segments to be generated for error correction after transmission can be based on a predicted number of segments that are lost, dropped, or corrupted during transmission across the data diode 106. For example, the data diode 106 may only be predicted to successfully transmit 80% of segments, so that one of every five segments are dropped. The number N of total data segments in the datagram can then be set to a value so that the number K is no more than 80% of the number N-K. Depending on the encoding algorithm, for a given amount of data 114, the values of the numbers N and K can vary. The data segments may be any suitable size according to the specific encoding algorithm and/or the transmission protocol used to transmit the data 114 and the datagram. In some embodiments, the number and size of the segments for the encoding algorithm can be different than the segments of the transmission protocol. For example, the encoding algorithm may operate on segments of 1 kB in size while the transmission protocol transmits segments of 576 B in size. In some examples, the encoding algorithm may operate on segments of 1 B in size.

After transmission across the data diode 106, the N segments of the datagram, or a portion of the N segments if some segments are dropped or corrupted, can be received at the receiver node 108. The receiver node 108 can be configured to reconstruct the data 114 from any K number of segments received; if more than K segments are successfully received, the receiver node 108 can discard the additional segments after successfully reconstructing the data 114 or use the additional segments to confirm the successful reconstruction. Because the datagram is encoded with the encoding algorithm, the original data payload may not be in a useable format for the CDS 102 to perform filtering or other security operations prior to passing the data to target 112. Therefore, the receiver node 108 reconstructing the original data may be the first operation done on the datagram once across the data diode 106.

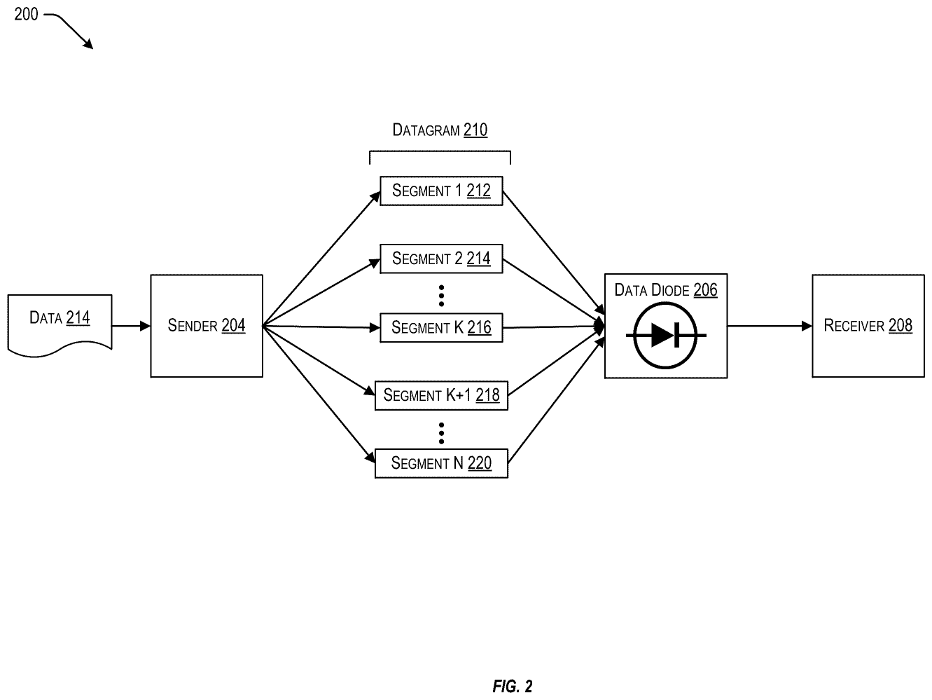

FIG. 2 is a simplified block diagram illustrating an erasure coding technique usable to transmit data 214 across a data diode 206 in a cross domain system (CDS) 200, according to some embodiments. The CDS 200 may be an example of CDS 102 described above with respect to FIG. 1. CDS 200 can include the data diode 206, a sender node 204, and a receiver node 208, which can be examples of the data diode 106, sender node 104, and receiver node 108 of FIG. 1, respectively.

As shown in FIG. 2, the sender node 204 can receive data 214 and generate a datagram 210 using an encoding algorithm. The encoding algorithm may be a forward error checking algorithm and, in particular, may be an erasure coding algorithm. For example, the encoding algorithm may be a Reed-Solomon code. The sender node 204 can use the encoding algorithm to generate a plurality of segments of data for the datagram 210 to be transmitted across the data diode 206. The datagram 210 can include segment 1 212, segment 2 214, segment K 216, segment K+1 218, segment N 220, and additional segments between segment 2 214 and segment K 216 and between segment K+1 218 and segment N 220 (not shown). The datagram 210 can therefore include N total segments, with N an integer value selected based on the parameters of the encoding algorithm, the amount of data 214, and/or the transmission protocol for sending the datagram 210 across the data diode 206. The value K may be an integer corresponding to the number of segments of data in data 214. For example, for equally sized segments of 128 KB, if data 214 is 512 kB, then K can equal 4. For an erasure coding algorithm, the value of N will be greater than the value of K, so that the number of segments of the datagram 210 exceeds the number of segments of data 214. In some embodiments, the segments 212-220 may be equally sized. In some examples, the size of the segments may be 1 byte; however, any suitable size for the segments can be used based on the encoding algorithm. One skilled in the art would appreciate several variations of the embodiments of the disclosure.

Once the sender node 204 has generated the datagram 210, the segments can be transmitted across the data diode 206. In some instances, the segments of the datagram 210 can be transmitted sequentially across the data diode 206. For example, the sender node 204 can transmit segment 1 212 first across the data diode 206, then segment 2 214, and so on until segment N 220 is transmitted. In some embodiments, the sender node 204 can be configured to transmit the segments 212-220 of the datagram 210 in any other order sequentially across the data diode 206. For example, segment K 216 may be transmitted first, followed by segment N 220, and so on. Because the original data 214 can be reconstructed from any K segments of the datagram 210, the order of transmission across the data diode 206 does not affect the ultimate receipt and reconstruction of the data 214 in the secure network.

In some embodiments, the sender node 204 can encapsulate the segments 212-220 of the datagram 210 as the payload of a particular transmission unit across the data diode 206. For example, the sender node 204 can be configured to apply header blocks, parity-checking bits, or other protocol-specific information to the segments when transmitting them across the data diode 206. The additional information can be used by the receiver node 208 to determine whether an individual segment was successfully received across the data diode 206. For example, the sender node 204 can encapsulate segment 1 212 with a header block including a parity bit before transmitting the encapsulated segment across the data diode 206. Upon receiving the encapsulated segment, the receiver node 208 can check the parity bit and header information to determine whether the data payload (e.g., segment 1 212) was received without corruption (e.g., bit flipping error, etc.). In some embodiments, the sender node 204 can include supplemental information about the transmission when sending one or more segments across the data diode 206. For example, the sender node 204 can send an initial packet to the receiver node 208 to inform the receiver node 208 of how many segments should be included in the following datagram and the encoding algorithm used to encode the segments. The sender node 204 may also include the supplemental information (or portions of the supplemental information) in the header block or other encapsulating data of each data segment of the datagram 210 when transmitting the datagram 210 across the data diode 206.

The receiver node 208 can receive all or a portion of the segments 212-220 of datagram 210. With at least K segments, the receiver node 208 can reconstruct the data 214. Reconstructing the data 214 can include applying an inverse of the encoding algorithm. The receiver node 208 can begin reconstructing the data 214 after the first K segments are successfully received. In this case, the receiver node 208 may ignore the remaining segments transmitted across the data diode 206 (although the sender node 204 may be configured to send all N segments of datagram 210).

In some embodiments, the datagram 210 may be a portion of data 214. For example, if data 214 is a large file to be transmitted into the secure network, then the sender node 204 can apply the encoding algorithm to a smaller portion of the data 214, so that datagram 210 represents the portion of the data 214. The sender node 204 can then generate additional datagrams for the remaining portions of the data 214 to transmit across the data diode 206.

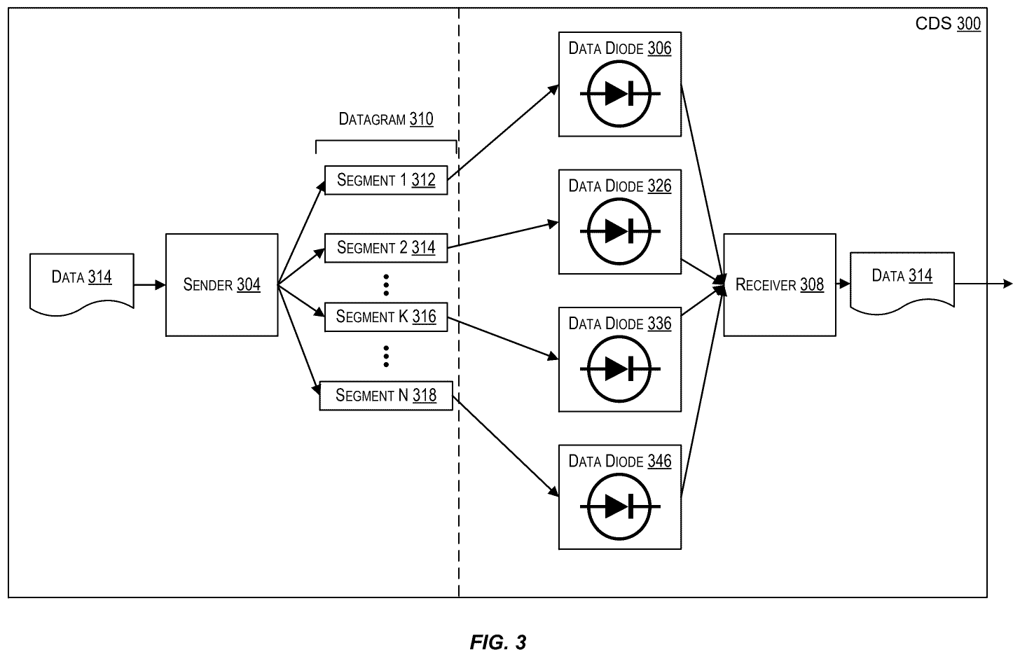

FIG. 3 is a simplified block diagram illustrating a cross domain system (CDS) 300 including a plurality of data diodes 306-346 usable for fully parallel transmission of data segments, according to some embodiments. The CDS 300 can be an example of CDS 200 described above with respect to FIG. 2. The CDS 300 can include a sender node 304 and receiver node 308, which can be examples of sender node 204 and receiver node 208 of FIG. 2, respectively. The CDS 300 can include multiple data diodes, including data diode 306, data diode 326, data diode 336, and data diode 346. In some embodiments, the CDS 300 can include more or fewer data diodes than shown in FIG. 3. Each data diode 306-346 can be an example of other data diodes described herein, including data diode 206 of FIG. 2 and data diode 106 of FIG. 1.

The data diodes 306-346 can allow for parallel transmission of segments of a datagram 310 into the secure network. The vertical dashed line can represent the demarcation between the “low side” and “high side” of the communication channel within the CDS 300 into to the secure network. The sender node 304 can be configured to generate the datagram 310 having N segments for N data diodes 306-346. For example, segment 1 312 can be transmitted across data diode 306, segment 2 314 can be transmitted across data diode 326, segment K 316 can be transmitted across data diode 336, and segment N 318 can be transmitted across data diode 346. The datagram 310 can therefore be transmitted to receiver node 308 in parallel in the amount of time to transmit a single segment across a data diode.

In some embodiments, the number of data diodes may be fewer than the number of segments, so that a first batch of segments of the datagram 310 can be transmitted across the data diodes in parallel, followed by subsequent batches of segments of the datagram 310 in parallel. As with other embodiments described herein, the receiver node 308 can receive K segments of the datagram 310 and reconstruct data 314. Having a CDS 300 with multiple data diodes can both speed up the transmission of the datagrams across the data diodes (since the parallel transmission can be substantially faster than sequential transmission) and improve redundancy of the CDS 300 by allowing the CDS 300 to continue to function if there is a failure in one or more of the data diodes (e.g., data diodes 306-346). Allowing for multiple physical data diodes allows the distributed computing system to compensate for brief interruptions of the transmission inherent to high-speed optical transmission systems caused by, for example, link flaps while maintaining high end-to-end efficiency. As discussed in more detail below, if there are fewer data diodes in the CDS 300 than there are segments in the datagram 310, the sender node 304 can transmit some batches of segments in parallel and then other batches sequentially across different data diodes.

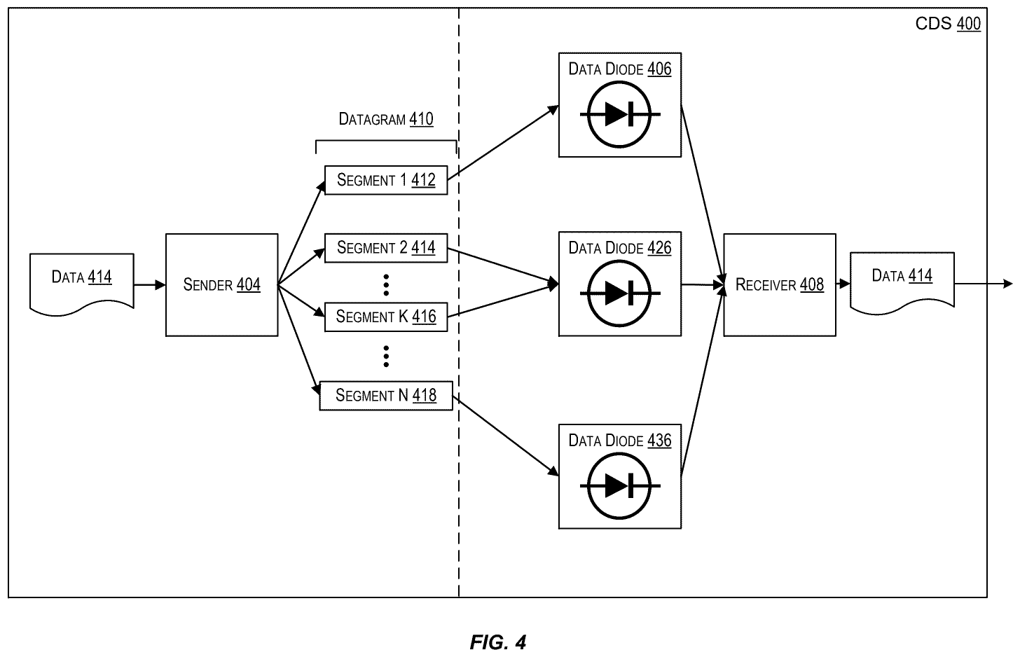

FIG. 4 is another simplified block diagram illustrating a cross domain system (CDS) 400 including a plurality of data diodes 406-446 usable for partially parallel transmission of data segments, according to some embodiments. The CDS 400 can be an example of CDS 300 described above with respect to FIG. 3. The CDS 400 can include a sender node 404 and receiver node 408, which can be examples of sender node 304 and receiver node 308 of FIG. 3, respectively. The CDS 400 can include multiple data diodes, including data diode 406, data diode 426, and data diode 436. Each data diode 406-436 can be an example of other data diodes described herein, including data diodes 306 of FIG. 3.

In the embodiment shown in FIG. 4, the CDS 400 can include a plurality of data diodes but not enough to transmit a complete datagram 410 in parallel. For example, datagram 410 can include N segments (e.g., segment 1 412, segment 2 414, segment K 416, and segment N 418) to be transmitted across the three data diodes 406-436. The sender node 404 can then be configured to transmit a portion of the segments of the datagram 410 in parallel across the data diodes 406-436 and another portion of the segments of the datagram 410 in sequence across one or more of the data diodes 406-436. For example, segment 1 412, segment 2 414, and segment N 418 can be transmitted in parallel across data diode 406, data diode 426, and data diode 436, respectively. Once segment 2 414 has been transmitted across data diode 426, then the sender node 404 can transmit segment K 416 across data diode 426. The order of the sequential transmission may not matter in some examples. For instance, the sender node 404 could instead transmit segment K 416 first across data diode 426 and then transmit segment 2 414 across data diode 426. The receiver node 408 can then reconstruct the data 414 from any K received segments of the datagram 410.

In some embodiments, the sender node 404 can be configured to generate additional datagrams. Alternatively or in addition to fully parallel or partially parallel transmission of segments of a single datagram, the sender node 404 can also transmit datagrams in parallel across different data diodes. For example, the sender node 404 can transmit all segments of datagram 410 across data diode 406 in sequence while simultaneously transmitting the segments of an additional datagram across data diode 426. In certain embodiments, the sender node 404 may transmit the various segments across the data diodes according to a random selection of a particular data diode for each segment. In some embodiments, the sender node 404 may transmit the segments of datagram 410 in a round-robin fashion across the data diodes 406-436, thereby avoiding concurrent failure of multiple physical data diodes from corrupting the entire datagram stream. For example, segment 1 412 can be transmitted across data diode 406, segment 2 414 can be transmitted across data diode 426, segment 3 (not pictured) can be transmitted across data diode 436, a fourth segment can be transmitted across data diode 406, and so on cycling through the available data diodes.

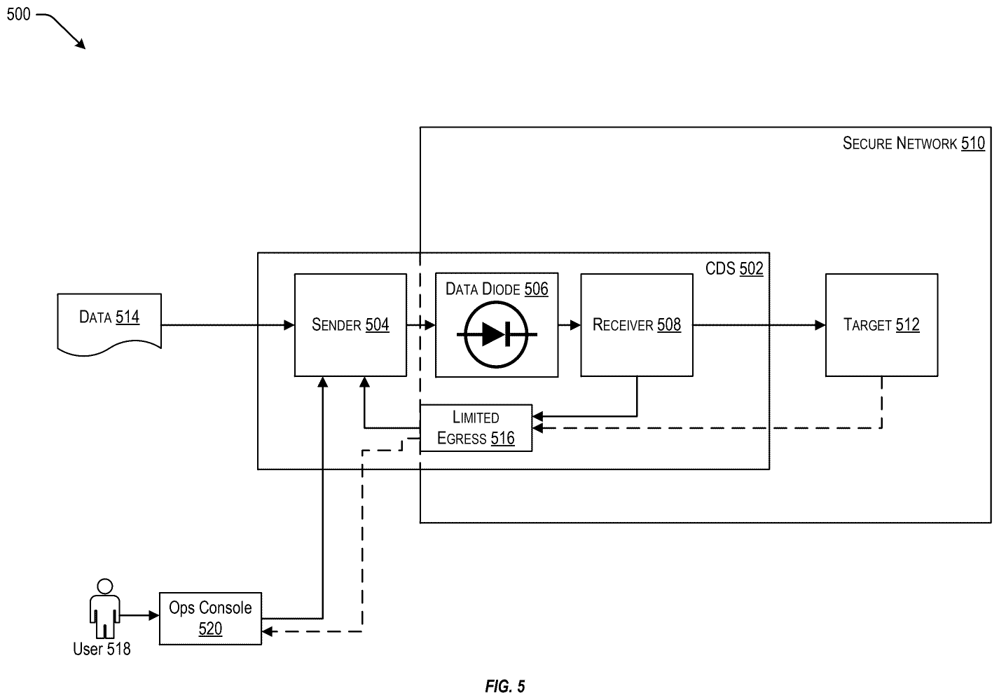

FIG. 5 is a simplified block diagram illustrating a cross domain system (CDS) 502 with a limited egress channel 516 for providing feedback information to a sender node 504, according to some embodiments. The CDS 502 can be an example of CDS 102 described above with respect to FIG. 1. The CDS 502 can provide an interface to allow data 514 into the secure network 510 from external sources within a larger distributed computing system 500. The distributed computing system 500 may be an example of distributed computing system 100 of FIG. 1. Secure network 510 may be an example of secure network 110 of FIG. 1, while sender node 504, data diode 506, and receiver node 508 may be examples of similarly named components described herein, including sender node 104, data diode 106, and receiver node 108 of FIG. 1

The CDS 502 can include a limited egress channel 516. The limited egress channel 516 can be implemented in hardware and/or software on the high side of the CDS 502, within the secure network 510. For example, the limited egress channel 516 may be a network interface of the same computing device hosting the receiver node 508 of the CDS 502. The limited egress channel 516 may be configured to only allow certain types and amounts of data to be sent from within the secure network 510. For example, the limited egress channel 516 may be configured to only transmit feedback information related to the data transmitted into the secure network through CDS 502. In some embodiments, the limited egress channel 516 may be implemented as another data diode with its own sender node, receiver node, and filter nodes to allow one-way transmission out from the secure network 510.

The limited egress channel 516 can be configured to provide feedback information about the drop rate of data transmitted over the data diode 506 and received by the receiver node 508. For example, the feedback information can be an actual drop rate for the data diode 506 as determined by the receiver node 508. The initial predicted drop rate for the data diode 506 can be, for example, 40%. If the sender node 504 generates and transmits a datagram having ten segments, and the receiver node 508 receives eight of the segments, then the actual drop rate of the data diode 506 for that transmission would be 20%. The receiver node 508 can determine the actual drop rate using supplemental information received from the sender node 504. The receiver node 508 can track the drop rate of the data diode 506 for some, any, or all of the data transmissions received across the data diode 506. The receiver node 508 can track the drop rate as an average of the actual drop rate over a period of time. For example, the receiver node 508 can determine an average hourly drop rate computed for each transmission occurring during an hour. The receiver node 508 can provide the actual drop rate to the sender node 504 via the limited egress channel 516. In some embodiments, a target 512 can track the drop rate in addition to or as an alternative to the receiver node 508.

The sender node 504 can receive an indication of the actual drop rate of the data diode 506 and update parameters of the encoding algorithm using the indication. Continuing the example above, if the initial predicted drop rate for the data diode 506 is 40%, then a correction parameter of the encoding algorithm can be the drop rate (i.e., 40% or 0.4). For an encoding algorithm that generates N segments for K segments of data, the data is recoverable if any N-K segments are not successfully transmitted across the data diode 506. Using the drop rate as a correction parameter, the number N of total segments can be set to

$$N \geq \frac{1}{( 1 - 0.4 )} \cdot K = 1.67 \cdot K .$$

If the data 514 can be partitioned into ten segments, then N can be 17 segments, so that at a predicted 40% drop rate no more than seven segments are expected to be lost and the original data 514 can be recovered from any ten remaining segments. If the sender node 504 receives an indication that the actual drop rate is 20%, then the sender node 504 can update the correction parameter. For example, the total segments generated can be updated to be

$$N \geq \frac{1}{( 1 - 0.2 )} \cdot K = 1.25 \cdot K .$$

For data 514 that can be partitioned into ten segments, N can be 13 so that the data 514 can be transmitted across the data diode 506 with a datagram having fewer total segments. By allowing updates to parameters of the encoding algorithm, the CDS 502 can optimize the bandwidth of the communication channel across the data diode 506 as well as reduce the amount of processing required to generate unnecessarily large datagrams from a non-optimal encoding algorithm, even when direct feedback from receiver node 508 is prevented by the one-way communication channel of the CDS 502.

In some embodiments, the drop rate information can be provided to an operations console 520. For example, the limited egress channel 516 can provide the actual drop rate information to an operations console 520. The operations console can be a computing system configured to monitor performance of the CDS 502. For example, excessive drop rate or failure of the physical components of the data diode 506 can be determined based on information provided to the operations console 520. In addition, a user 518 (e.g., operations personnel) can view the drop rate information and then make adjustments to the parameters of the CDS 502, including parameters of the encoding algorithm. In addition, in some embodiments the sender node 504 can use the drop rate information to select a different encoding algorithm. For example, if the actual drop rate is higher than predicted, a different encoding algorithm may be more efficient for generating a datagram from the data 514. Rather than adjust correction parameters of the initial encoding algorithm, the sender node 504 can select a different encoding algorithm.

In some embodiments, the drop rate can be determined without compromising the isolation and security of the secure network 510 by scheduling measurements of the channel across the CDS 502 using training or testing packets while the CDS 502 is disconnected from the target 512. For example, the CDS 502 can be connected to a testing target at predetermined intervals and used to receive the testing traffic. The intervals can be chosen in any granularity including, but not limited to, hourly, daily, weekly, monthly, etc. During the testing intervals, the receiver 508 can be disconnected from the target 512.

In some embodiments, the drop rate can be determined using a reference link that is configured similarly to the CDS 502 and can connected in parallel to the CDS 502. The reference link may not be part of the CDS 502 or the secure network 510. For example, a reference link including identically configured sender node, receiver node, and data diode as CDS 502 can be implemented at or near a data center hosting the secure network 510. The reference link may not connect to the secure network 510 but can be used to receive traffic, including data 514, from the distributed computing system 500 in parallel with CDS 502. The performance of the reference link can therefore be monitored without interrupting the communication link across the CDS 502 into the secure network 510. Because the reference link is configured similarly to CDS 502, a drop rate determined for the reference link can be a proxy for the drop rate of the data diode 506 in CDS 502. As with the embodiment described above, the drop rate of the reference link can be determined using synthetic data at predetermined intervals.

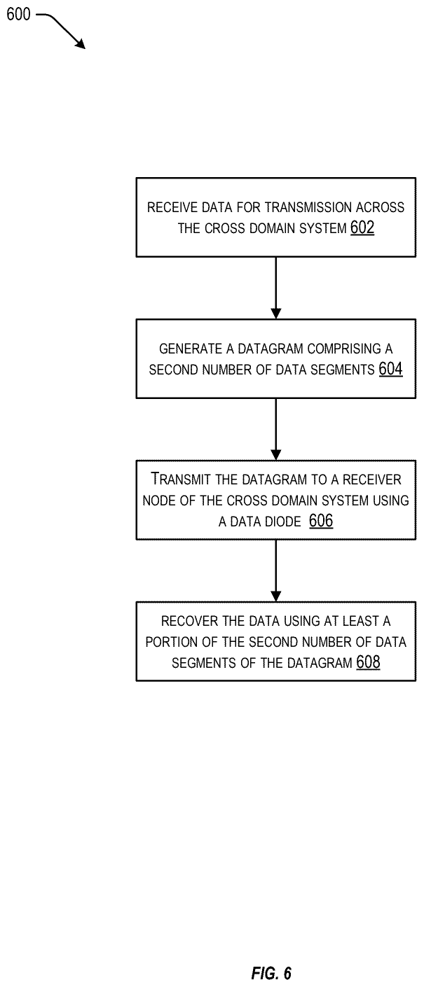

FIG. 6 is a flow diagram of an example process 600 for transmitting a datagram across a data diode using an encoding algorithm, according to some embodiments. The process 600 may be performed by one or more components of a cross domain system (CDS), including a sender node (e.g., sender node 104 of FIG. 1), a data diode (e.g., data diode 106 of FIG. 1), and a receiver node (e.g., receiver node 108 of FIG. 1). The CDS can be implemented using hardware and/or software of a computing environment (e.g., distributed computing system 100 of FIG.), including computing devices of a data center. In some embodiments, a computer-readable medium comprising computer-readable instructions that, upon execution by one or more processors of a CDS, can cause the CDS to perform the process 600. The operations of process 600 may be performed in any suitable order, and process 600 may include more or fewer operations than those depicted in FIG. 6.

Some or all of the process 600 (or any other processes and/or methods described herein, including process 700, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 600 can begin at block 602 with a sender node of the CDS receiving data for transmission across the CDS. The data can include a first number of data segments. For example, the data may be a file having size of 1 kB. Depending on the encoding algorithm, the data can be partitioned into 1,024 1 B segments, four 256 B segments, eight 128 B segments, or any other suitable number of segments. The number of segments of the data may be a value K.

At block 604, the sender node can generate a datagram. The datagram can have a second number of data segments. The datagram can be generated using an encoding algorithm. For example, the sender node can use a Reed-Solomon code to generate a datagram having N segments. In some embodiments, the encoding algorithm can be an erasure coding algorithm. The second number of data segments can be greater than the first number of data segments (e.g., N>K). Each of the N data segments can include information usable to decode and reconstruct the original data using any N−K number of data segments.

In some embodiments, generating the datagram can include determining the second number of data segments N using the first number of data segments K and an estimated drop rate for the data diode. For example, the data diode can have an estimated drop rate of 40%. The second number of data segments N can then be determined to be

$$N \geq \frac{1}{( 1 - 0.4 )} \cdot K = 1.67 \cdot K .$$

At block 606, the sender node can transmit the datagram to a receiver node of the CDS using a data diode. As described above, the data diode can be implemented in hardware as an optical link that includes an optical transmitter (e.g., a laser, a light-emitting diode, etc.) and an optical receiver (e.g., a photosensitive transistor). The datagram can be transmitted from a first terminal (e.g., optical transmitter) of the data diode to the second terminal (e.g., optical receiver) of the data diode. In some embodiments, the data diode may be implemented with software as a virtual data diode. Transmitting the datagram can include sending each segment of the datagram across the data diode sequentially.

In some embodiments, the data diode is a first data diode (e.g., data diode 306 of FIG. 3) of a plurality of data diodes (e.g., data diodes 306-346 of FIG. 3) of the CDS. Transmitting the datagram can include transmitting each data segment in parallel across a corresponding data diode of the plurality of data diodes. For example, if the datagram includes four data segments, then one data segment can be transmitted across each of data diodes 306-346 in parallel. In some embodiments, transmitting the datagram to the receiver node can include transmitting a first portion of the second number of data segments sequentially across the first data diode and transmitting a second portion of the second number of data segments sequentially across a second data diode of the plurality of data diodes. For example, if the datagram includes eight data segments, then four of the data segments can be transmitted sequentially across the first data diode and the other four data segments can be transmitted sequentially across the second data diode.

At block 608, the receiver node can recover the data using at least a portion of the second number of data segments of the datagram. For example, the sender node can transmit N total data segments of the datagram, and the receiver node can receive any number up to and including N data segments. The receiver node can use the encoding algorithm (e.g., an inverse process of the encoding algorithm) to reconstruct the data from any N−K data segments received.

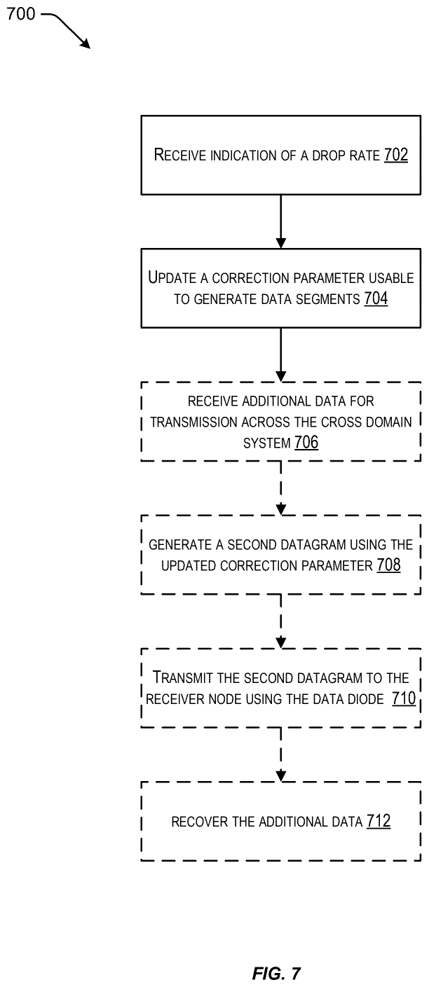

FIG. 7 is another flow diagram of an example process 700 for updating a correction parameter for the encoding algorithm using an indication of a drop rate, according to some embodiments. Similar to process 600 of FIG. 6, the process 700 may be performed by one or more components of a cross domain system (CDS), including a sender node (e.g., sender node 104 of FIG. 1), a data diode (e.g., data diode 106 of FIG. 1), and a receiver node (e.g., receiver node 108 of FIG. 1). The CDS can be implemented using hardware and/or software of a computing environment (e.g., distributed computing system 100 of FIG. 1), including computing devices of a data center. In some embodiments, a computer-readable medium comprising computer-readable instructions that, upon execution by one or more processors of a CDS, can cause the CDS to perform the process 700. The operations of process 700 may be performed in any suitable order, and process 700 may include more or fewer operations than those depicted in FIG. 7. The operations of process 700 can be performed after the operations of process 600.

The process 700 can begin at block 702 with the sender node receiving an indication of a drop rate associated with the transmission of a datagram to the receiver node. For example, after completing process 600, the receiver node can determine an actual drop rate for the transmission of the datagram across the data diode of the CDS. The receiver node can provide the indication to the sender node via a limited egress channel (e.g., limited egress channel 516 of FIG. 5). In some embodiments, the indication can be provided by an operations console communicatively connected to the low side of the CDS.

At block 704, the sender node can use the drop rate to update a correction parameter. The correction parameter may be usable to generate data segments for subsequent datagrams transmitted from the sender node to the receiver node using the data diode. For example, if the initial predicted drop rate for the data diode is 40% and the drop rate indicated to the sender node is 20%, then the sender node can update the correction parameter so that the number N of data segments to encode K data segments of data can decrease from 1.67·K to 1.25·K. In some examples, the values 1.67 and 1.25 may be the correction parameter and updated correction parameter respectively.

Once the sender node has updated the correction parameter of the encoding algorithm, the CDS can receive additional data for transmission across the data diode, at block 706. At block 708, the sender node can use the encoding algorithm with the updated correction parameter to generate a second datagram. For example, if the additional data can be partitioned into ten data segments, the second datagram can include 13 data segments (using the 1.25·K correction parameter). The sender node can transmit the second datagram to the receiver node using the data diode, at block 710, and the receiver node can recover the data using any N−K data segments of the second datagram, at block 712.

### Example Infrastructure as a Service Architectures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model may require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may need to first be set up. In some instances, the provisioning can be done manually, a provisioning tool may be utilized to provision the resources, and/or deployment tools may be utilized to deploy the code once the infrastructure is provisioned.

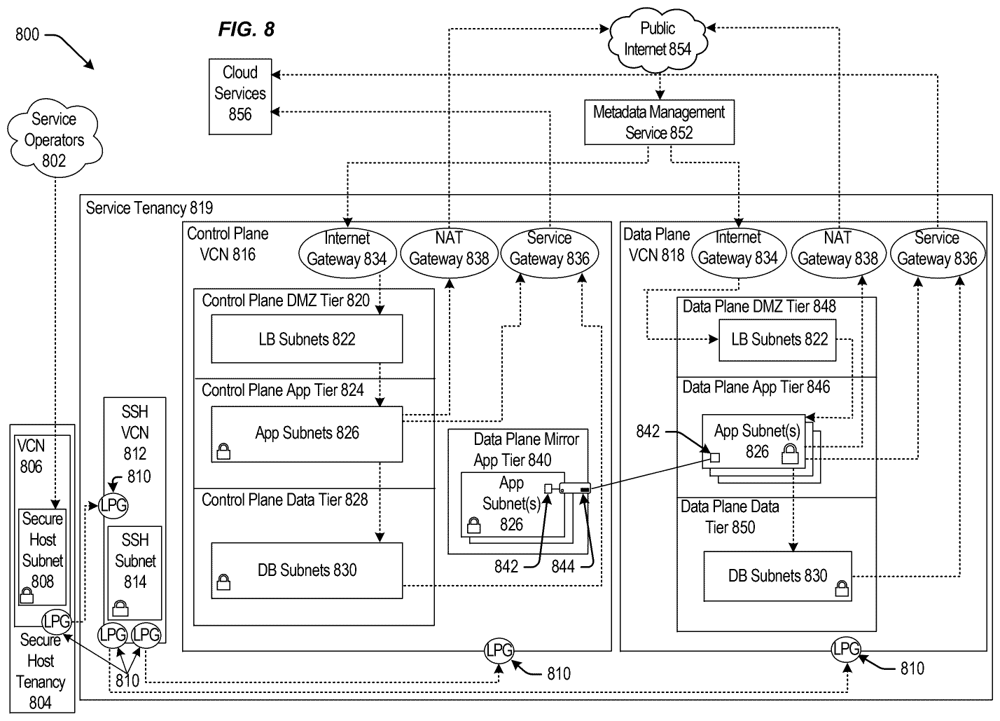

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively coupled to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users′, or other customers′, resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

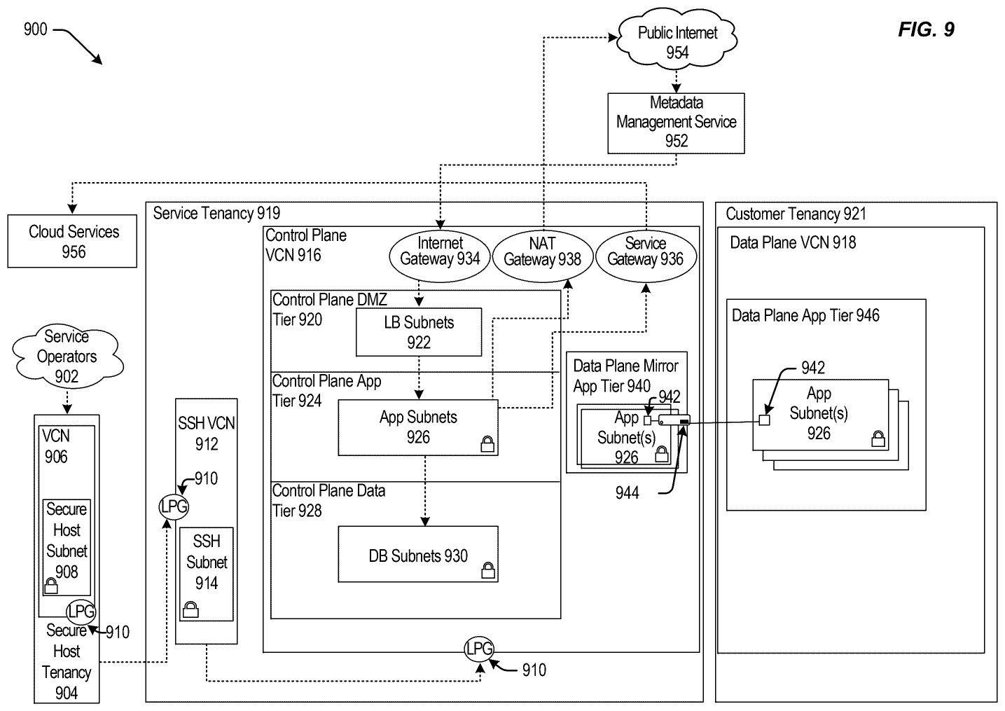

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively coupled to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

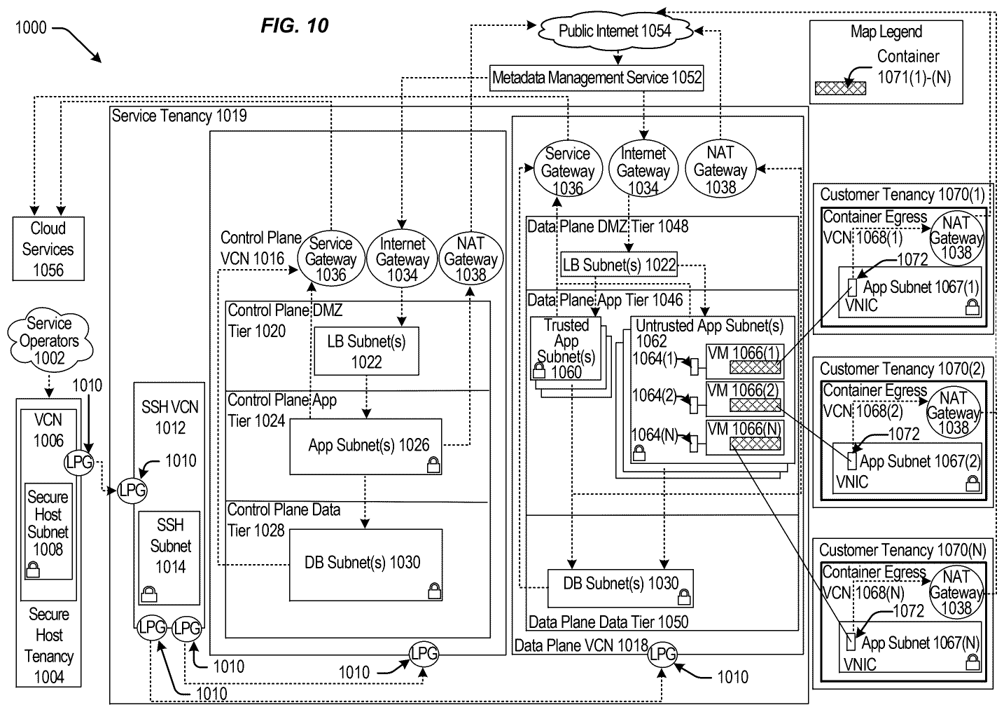

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane

DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

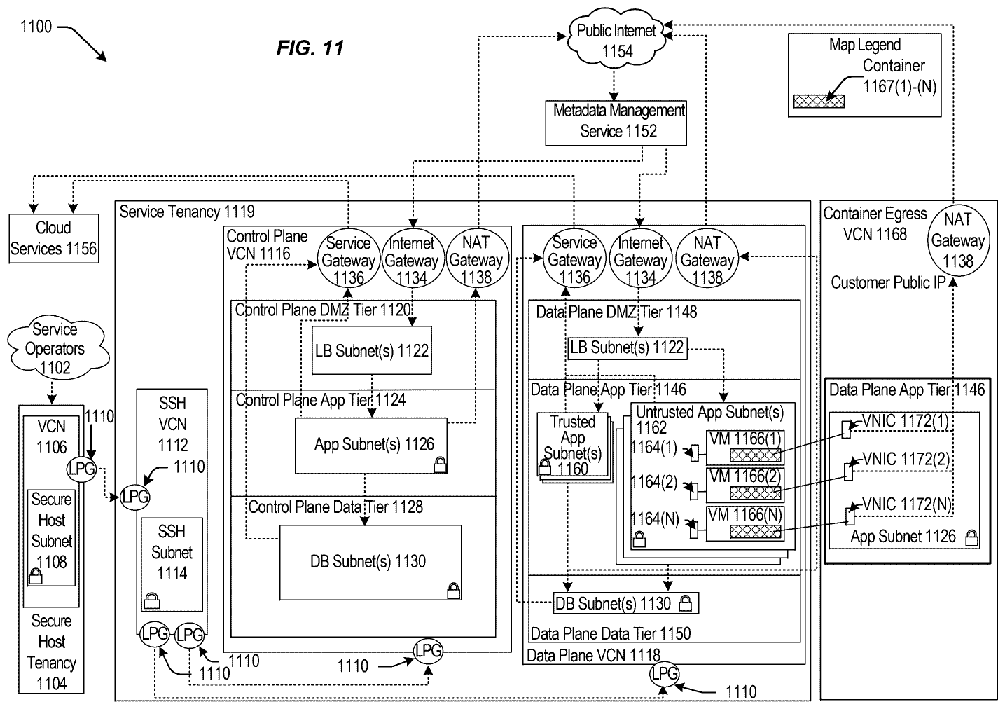

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

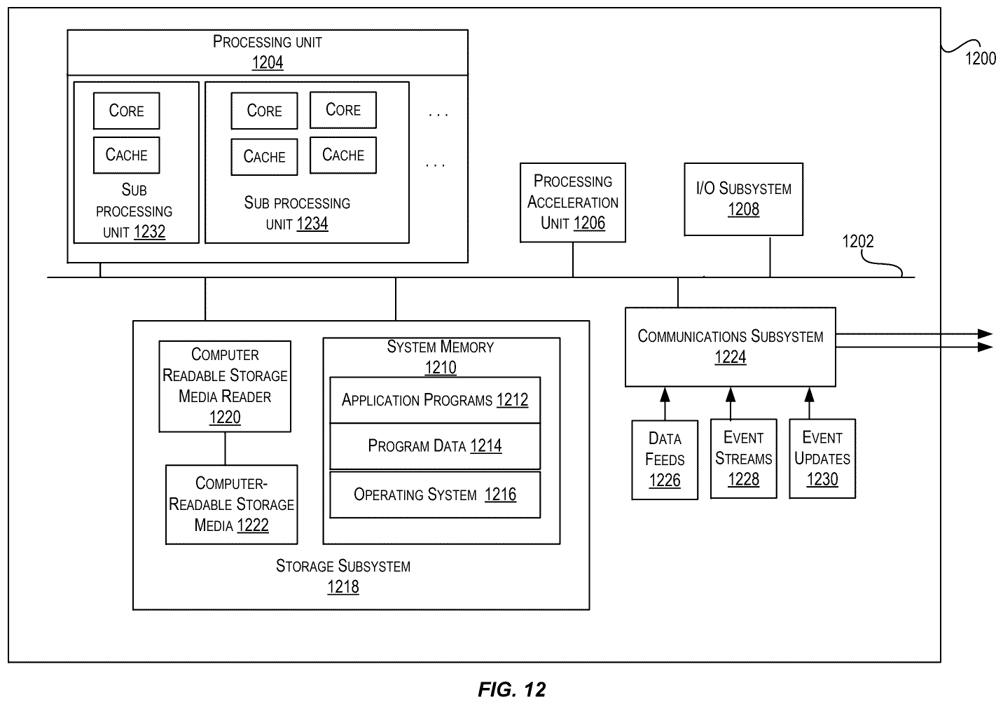

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that provides a tangible non-transitory computer-readable storage medium for storing software and data constructs that provide the functionality of the embodiments described in this disclosure. The software can include programs, code, instructions, scripts, etc., that when executed by one or more cores or processors of processing unit 1204 provide the functionality described above. Storage subsystem 1218 may also provide a repository for storing data used in accordance with the present disclosure.

As depicted in the example in FIG. 12, storage subsystem 1218 can include various components including a system memory 1210, computer-readable storage media 1222, and a computer readable storage media reader 1220. System memory 1210 may store program instructions that are loadable and executable by processing unit 1204. System memory 1210 may also store data that is used during the execution of the instructions (e.g., application programs 1212) and/or data that is generated during the execution of the program instructions (e.g., program data 1214). Various different kinds of programs may be loaded into system memory 1210 including but not limited to client applications, Web browsers, mid-tier applications, relational database management systems (RDBMS), virtual machines, containers, etc.

System memory 1210 may also store an operating system 1216. Examples of operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1200 executes one or more virtual machines, the virtual machines along with their guest operating systems (GOSs) may be loaded into system memory 1210 and executed by one or more processors or cores of processing unit 1204.

System memory 1210 can come in different configurations depending upon the type of computer system 1200. For example, system memory 1210 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1210 may include a basic input/output system (BIOS) containing basic routines that help to transfer information between elements within computer system 1200, such as during start-up.

Computer-readable storage media 1222 may represent remote, local, fixed, and/or removable storage devices plus storage media for temporarily and/or more permanently containing, storing, computer-readable information for use by computer system 1200 including instructions executable by processing unit 1204 of computer system 1200.

Computer-readable storage media 1222 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1200.

Machine-readable instructions executable by one or more processors or cores of processing unit 1204 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a sender node of a cross domain system, data for transmission across the cross domain system, the data comprising a first number of data segments;
generating, by the sender node using the data and according to an encoding algorithm, a datagram comprising a second number of data segments, the second number of data segments greater than the first number of data segments;
transmitting, by the sender node, the datagram to a receiver node of the cross domain system using a data diode; and
recovering, by the receiver node, the data using at least a portion of the second number of data segments of the datagram.

2. The method of claim 1, wherein the encoding algorithm comprises an erasure coding algorithm.

3. The method of claim 1, wherein generating the datagram comprises determining the second number of data segments using the first number of data segments and an estimated drop rate for the data diode.

4. The method of claim 1, wherein transmitting the datagram to the receiver node comprises transmitting each data segment of the second number of data segments sequentially over the data diode.

5. The method of claim 1, wherein the data diode is a first data diode of a plurality of data diodes of the cross domain system, and wherein transmitting the datagram to the receiver node comprises transmitting each data segment of the second number of data segments in parallel using a corresponding data diode of the plurality of data diodes.

6. The method of claim 1, wherein the data diode is a first data diode of a plurality of data diodes of the cross domain system, and wherein transmitting the datagram to the receiver node comprises transmitting a first portion of the second number of data segments sequentially across the first data diode and transmitting a second portion of the second number of data segments sequentially across a second data diode of the plurality of data diodes.

7. The method of claim 1, further comprising:
receiving, by the sender node, an indication of a drop rate associated with the transmission of the datagram to the receiver node; and
updating, by the sender node using the drop rate, a correction parameter usable to generate data segments for subsequent datagrams transmitted from the sender node to the receiver node using the data diode.

8. A cross domain system, comprising:
one or more processors; and
one or more memories storing computer-executable instructions that, when executed by the one or more processors, cause the cross domain system to:
receive, by a sender node of the cross domain system, data for transmission across the cross domain system, the data comprising a first number of data segments;
generate, by the sender node using the data and according to an encoding algorithm, a datagram comprising a second number of data segments, the second number of data segments greater than the first number of data segments;
transmit, by the sender node, the datagram to a receiver node of the cross domain system using a data diode; and
recover, by the receiver node, the data using at least a portion of the second number of data segments of the datagram.

9. The cross domain system of claim 8, wherein the encoding algorithm comprises an erasure coding algorithm.

10. The cross domain system of claim 8, wherein generating the datagram comprises determining the second number of data segments using the first number of data segments and an estimated drop rate for the data diode.

11. The cross domain system of claim 8, wherein transmitting the datagram to the receiver node comprises transmitting each data segment of the second number of data segments sequentially over the data diode.

12. The cross domain system of claim 8, wherein the data diode is a first data diode of a plurality of data diodes of the cross domain system, and wherein transmitting the datagram to the receiver node comprises transmitting each data segment of the second number of data segments in parallel using a corresponding data diode of the plurality of data diodes.

13. The cross domain system of claim 8, wherein the data diode is a first data diode of a plurality of data diodes of the cross domain system, and wherein transmitting the datagram to the receiver node comprises transmitting a first portion of the second number of data segments sequentially across the first data diode and transmitting a second portion of the second number of data segments sequentially across a second data diode of the plurality of data diodes.

14. The cross domain system of claim 8, wherein the one or more memories store additional instructions that, when executed by the one or more processors, cause the cross domain system to further:
receive, by the sender node, an indication of a drop rate associated with the transmission of the datagram to the receiver node; and
update, by the sender node using the drop rate, a correction parameter usable to generate data segments for subsequent datagrams transmitted from the sender node to the receiver node using the data diode.

15. A non-transitory computer-readable medium comprising executable instructions that, when executed by one or more processors of a cross domain system, cause the cross domain system to:
receive, by a sender node of the cross domain system, data for transmission across the cross domain system, the data comprising a first number of data segments;
generate, by the sender node using the data and according to an encoding algorithm, a datagram comprising a second number of data segments, the second number of data segments greater than the first number of data segments;
transmit, by the sender node, the datagram to a receiver node of the cross domain system using a data diode; and
recover, by the receiver node, the data using at least a portion of the second number of data segments of the datagram.

16. The non-transitory computer-readable medium of claim 15, wherein generating the datagram comprises determining the second number of data segments using the first number of data segments and an estimated drop rate for the data diode.

17. The non-transitory computer-readable medium of claim 15, wherein transmitting the datagram to the receiver node comprises transmitting each data segment of the second number of data segments sequentially over the data diode.

18. The non-transitory computer-readable medium of claim 15, wherein the data diode is a first data diode of a plurality of data diodes of the cross domain system, and wherein transmitting the datagram to the receiver node comprises transmitting each data segment of the second number of data segments in parallel using a corresponding data diode of the plurality of data diodes.

19. The non-transitory computer-readable medium of claim 15, wherein the data diode is a first data diode of a plurality of data diodes of the cross domain system, and wherein transmitting the datagram to the receiver node comprises transmitting a first portion of the second number of data segments sequentially across the first data diode and transmitting a second portion of the second number of data segments sequentially across a second data diode of the plurality of data diodes.

20. The non-transitory computer-readable medium of claim 15, wherein the one or more memories store additional instructions that, when executed by the one or more processors, cause the cross domain system to further:
receive, by the sender node, an indication of a drop rate associated with the transmission of the datagram to the receiver node; and
update, by the sender node using the drop rate, a correction parameter usable to generate data segments for subsequent datagrams transmitted from the sender node to the receiver node using the data diode.
